(19) United States
(12) Patent Application Publication
(10) Pub. No.: US 2022/0340092 A1
(43) Pub. Date: Oct. 27, 2022

(54) Detachable Front License Plate Bracket

(71) Applicant: Martin Kulcsar, Caledon (CA)

(72) Inventor: Martin Kulcsar, Caledon (CA)

(21) Appl. No.: 17/301,989

(22) Filed: Apr. 21, 2021

(51) Int. Cl. B60R 13/10

(52) U.S. Cl. CPC B60R 13/105

(57) ABSTRACT

A bracket assembly that allows quick removal of the front license plate of an automotive vehicle having a primary plate which comprises one or more L braces, and a secondary plate comprising one or more female snap fasteners that are adapted and aligned to allow the attachment and detachment of the primary and secondary plate, where said secondary plate comprises one or more mounting holes for said license plate, further comprising of a mounting location for a safety tether.

### FIELD OF INVENTION

The present invention relates to a detachable front license plate mounting system, and more particularly, for vehicles that have an indented grill, fog light or other similar cutout. The present invention is intended for an automotive vehicle that does not have an integrally designed and designated front license plate mounting location embodied in the front fascia of the bumper.

### BACKGROUND

More than half of the states in the United States require an automotive vehicle to have a license plate mounted on the front of the bumper. Traditional brackets require holes to be drilled into the front of the bumper to attach the bracket. This not only takes away from the value and visual appeal intended by the manufacturer, but it limits the owner to a singular placement that is pre-decided. Automotive enthusiasts like to customize their vehicles to be more presentable, and often resort to alternative license plate mounting methods such as zip-ties and tow hook brackets. Many enthusiasts enjoy taking pictures of their vehicles, and a license plate will often draw the focus away from the elegant features of the vehicle, or even pose a risk to the owners safety. Tow hook brackets composed of metal or other composite materials often require special tools and are time consuming to remove. There are previous inventions that aim to solve this problem, but they are often expensive to purchase, may require electrical wiring, and are often vehicle specific. Some of said products have advantages such as a remote control or they screw into existing holes. The advantages of this invention are: the narrow profile which allows it to mount to virtually any vehicle, the lower cost to manufacture due to a simplistic design of components, the ease of use during operation, the included safety features, and the ability to mount anywhere in upright or reverse orientation.

### BRIEF DESCRIPTION OF THE INVENTION

The present invention seeks to provide a detachable license plate bracket that consists of two parts. Part 1 is a base plate comprising two L-shaped braces containing male snap fasteners. Part 2 is a mounting plate comprising two female snap fasteners and a safety tether. Part 1 and part 2 fit together by connecting said snap fasteners with an applied force, allowing the user to quickly attach and detach the parts when desired.

### BRIEF DESCRIPTION OF DRAWINGS

The present invention will be more fully understood by reference to the specification of the preferred embodiment when read in conjunction with the accompanying drawings in which the reference numbers refer to like parts throughout the several views.

FIG. 1 shows a top view of the present invention.

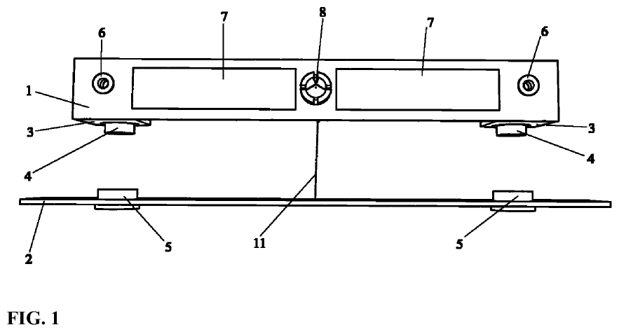

FIG. 2 shows a front perspective view that displays most of the features of the present invention.

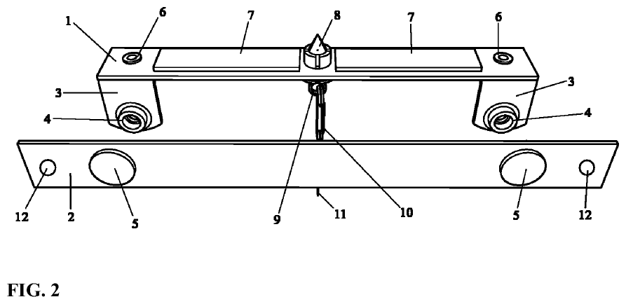

FIG. 3 shows a side perspective view that displays most of the features of the present invention.

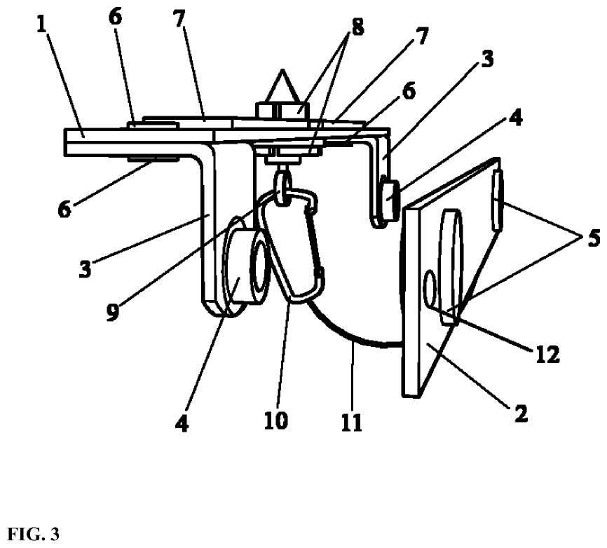

FIG. 4 shows a rear perspective view that displays most of the features of the present invention.

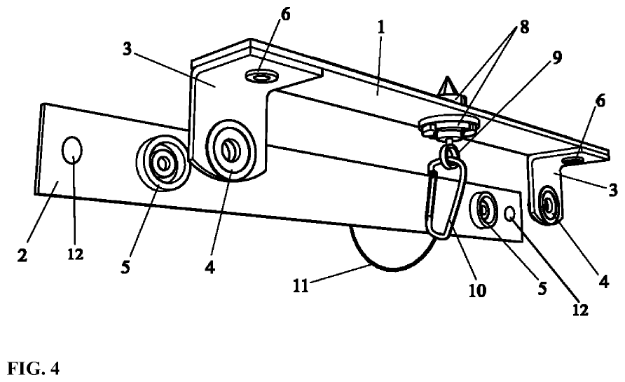

### DETAILED DESCRIPTION OF THE INVENTION

The present invention is composed of two parts: part one which attaches to the underside of a bumper cutout on the front fascia of the bumper (1), and part two which holds the license plate (2).

In this invention, the preferred material is aluminum since it is fairly rigid and is corrosion resistant. Component 1 in this invention is 6 inches in length, ¾ inches in width, and ⅛ inches in thickness, but shall be of any thickness or any material such as carbon fibre, nylon, or other composites, but is not limited to any material. Component 1 comprises two L-shaped braces (3) that are connected with welds or a strong adhesive; not limited to any brand or composition of adhesives and reinforced by rivets: (6) a headed pin or bolt with a shank that passes through a hole and is used to connect one or more layers of material. Machine screws, socket bolts, barrel nuts, or other fasteners may be used as long as they have a flat head profile that does not protrude and cause issues mounting to the bumper surface.

The L-shaped brace (3) is equipped with a male snap fastener (4) on each, that shall be composed of aluminum, nickel, nylon, other plastics or other corrosion resistant composite materials. The base plate (1) has a circular cutout in the centre to allow for a bumper tab fastener (8) to firmly bind said baseplate to the bumper, with the assistance of the double sided tape (7), not limited to any specific adhesives or compositions. The bumper tab fastener (8) may be of any shape, size, or material, and has an eyelet screw (9) through the centre to allow a mounting point for the safety tether (11).

Part two (2), also composed of aluminum or other similar rigid material such as plastic or composites, has a length of 7½ inches, width of ¾ inches, and a thickness of ⅛ inches but is not limited to these dimensions. It contains two female snap fasteners (5) which can be composed of aluminum, nickel, plastic, nylon, or other corrosion resistant composite materials. This part (2) includes two holes (12) which are spaced 7 inches apart, that allow for the license plate to be secured by means of screws, bolts, or other fastening methods. This part is also equipped with a safety tether (11) which can be of any length or material such as rubber composites, rope, chain, cable or other. Attached to the tether is a carabiner (10) which may be of any size or color, but is not limited to a carabiner and can include any clip or hook method that is secure and easy to operate.

To operate the invention, the user shall mount part one (1) to a clean bumper surface by drilling a hole the size of the bumper tab (8), and using the tape (7) as assistance to maintain correct orientation. The tether (11) shall be connected to the eyelet (9) on part one (1), then the snap fasteners (4, 5) attached to each other. Once assembled, the bracket shall not fall or become dislodged while the vehicle is in motion, if in the rare case it does; the safety tether (11) will prevent the plate from making contact with the road and potentially causing damage to other road users.

1. A bracket assembly for mounting a front license plate to an automotive vehicle and allowing quick removal of said license plate from the vehicle, where said vehicle does not have an integrally designed and designated mounting location for said license plate embodied on the external surface of the bumper fascia, said bracket comprising of two parts; a primary plate which comprises one or more L braces, wherein said braces are attached to said primary plate with welds or a strong adhesive, and reinforced with rivets or other fasteners, said braces comprising one or more male snap fasteners, said primary plate comprising one or more holes for a bumper tab fastener, further comprising an adhesive tape to ensure a strong and correctly oriented mounting of said primary plate to the underside of a grill, foglight or similar cutout on the bumper fascia; a secondary plate comprising one or more female snap fasteners that are adapted and aligned to allow the attachment and detachment of the primary and secondary plate, where said secondary plate comprises one or more mounting holes for said license plate, further comprising of a mounting location for a safety tether.

2. The bracket assembly of claim 1, wherein the primary plate consists of a flat mounting surface that has a small profile to allow fitment on most vehicles, comprising said L braces and male snap fasteners from claim 1 which are mounted at a 45 to 90 degree angle, and wherein said primary plate is secured to the bumper fascia with one or more bumper tab fasteners and an adhesive, said bumper tabs comprising an eyelet to allow a mounting point for a safety tether.

3. The bracket of claim 1, wherein the secondary plate consists of a flat mounting surface to allow the attachment of said front license plate, comprising two or more holes of any size to allow screws or other fasteners to firmly bind said license plate to said secondary plate.

4. The bracket of claim 1, wherein the secondary plate comprises one or more female snap fasteners which are symmetrically spaced at a distance which allows said male snap fasteners from the primary plate to align and attach to the female snap fasteners of the secondary plate.

5. The bracket of claim 1, wherein the secondary plate comprises a method for the attachment of a safety tether, said tether comprising a carabiner or other similar clip or hook which allows said secondary plate to be tethered to the eyelet of the primary plate, to ensure the two components do not become separated in the event of an accident.
